(19) United States
(12) Patent Application Publication
(10) Pub. No.: US 2025/0012825 A1
(43) Pub. Date: Jan. 9, 2025

(54) LABORATORY SYSTEM OR DEVICE WITH IMPROVED REAGENT HANDLING AND METHOD FOR IMPROVING REAGENT HANDLING IN A LABORATORY SYSTEM OR DEVICE

(71) Applicant: Roche Molecular Systems, Inc., Pleasanton, CA (US)

(72) Inventors: Alan Furlan, Lucerne (CH); Raymond Minder, Lucerne (CH); Stefan Vollenweider, Aargau (CH)

(21) Appl. No.: 18/711,510

(22) PCT Filed: Nov. 17, 2022
(86) PCT No.: PCT/EP2022/082187

§ 371 Date: May 17, 2024

(30) Foreign Application Priority Data
Nov. 18, 2021 (EP) 21208915.5

(51) Int. Cl. G01N 35/10; B01L 3/00; G01N 35/00

(52) U.S. Cl. CPC G01N 35/1002; B01L 3/527; G01N 35/00584

(57) ABSTRACT

A laboratory system or device, comprising a reagent storage area (1) comprising at least two reagent drawers (2, 3) mounted slidably between an open position (O) and a closed position (C), each of the reagent drawers comprising receptacles for a plurality of reagent cartridges (RC1, RC2), and at least two locking mechanisms (4, 5) for respectively locking/unlocking the at least two reagent drawers (2, 3) when in the closed position (C), at least one robotic handler (6) and a control unit (7), wherein the reagent storage area (1) is subdivided in a loading zone (LZ), a storage zone (SZ) and a pipetting zone (PZ), and the reagent storage area (1) further comprises a handling zone (HZ).

### FIELD OF THE INVENTION

The invention relates to a laboratory system or device with improved reagent handling and a method for improving reagent handling in a laboratory system or device.

### BACKGROUND

In fully automated laboratory systems and devices, there is the desire to increase the throughput while minimizing the hands-on time by an operator. In particular, laboratory systems and devices shall provide «random access» and «continuous loading» of samples and supplies, e.g. consumables, reagents, controls etc. Under circumstances, an operator should be able to load and unload samples and supplies at any point of time

A solution consists in dedicated loading/unloading areas for single samples, as well as supplies for processing single samples (such as a cartridge containing all reagents for processing a single sample). However, single sample processing is typically associated with high cost per test, and in low throughput per analyzer of a certain size. This is particularly the case if the process involves a long process step as PCR. To reduce cost per test, reagents are often provided in containers or cartridges containing all the reagents necessary for performing a given assay which can be used for a larger number of tests, and samples are processed in batches of typically 5 to 96 samples.

If the same test is performed for all samples of a batch, then only one set of test-specific reagents is required for this batch. If several tests are performed within a batch, then several sets of test-specific reagents must be available. Typically, a laboratory has a menu of several different tests that are performed on a daily basis on the same laboratory system or analyzer. In order to minimize the daily hands-on time for users to load and unload reagents, and maximize the walk-away time, it is desirable to store all commonly used assay-specific reagents on board of the analyzer. Furthermore, the on-board storage must be temperature-controlled in order to ensure reagent stability within the specified maximum storage duration.

In order to achieve sufficient throughput, the batches of samples are processed in an interleaved mode. This means that when a batch run starts, the next batch is already being processed.

Therefore, the laboratory system has to ensure that the specific reagents for both batch runs are available. In some cases, more than two batch runs may be running (although not simultaneously) in an interleaved mode.

It is therefore clear that a plurality of reagent cartridges has to be available during operation of the laboratory system or device. However, the available space is limited by different factors. There is therefore the need to improve reagent handling in known laboratory systems and devices.

In addition, the reagent cartridges are often stored on the system or device in receptacles and drawers of a reagent storage zone that need to be locked most of the time in order to prevent injuries of an operator, since the reagent cartridges are often transferred from and to the reagent storage zone by robotic handlers. In addition, a reagent cartridge should often be available at any time when the batch run is being processed.

As a consequence, an operator may have a very limited access to the reagent storage zone.

It is therefore aim of the present invention to provide a laboratory system or device with improved reagent handling and a method for improving reagent handling in a laboratory system or device which allows an optimal loading/unloading of reagent cartridges while the system or device is being operated. In addition, the laboratory system or device should provide a maximum of onboard capacity for reagent cartridges in a temperature controlled area, while keeping the footprint of the system or device as small as possible. The invention also ensures safety of an operator during loading/unloading of reagents cartridges and process safety, e.g. prohibiting removal of reagent cartridges that are needed by the instrument while being operated.

This is achieved by a laboratory system or device and by a method according to the independent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

The laboratory system or device according to the present invention comprises a reagent storage area comprising at least two reagent drawers mounted slidably between an open position and a closed position, each of the reagent drawers comprising receptacles for a plurality of reagent cartridges.

The system or device further comprises at least two locking mechanisms for respectively locking/unlocking the at least two reagent drawers when in the closed position. Locking of the respective reagent drawer is important to guarantee both security of an operator and of the process as cited above.

The system or device further comprises at least one robotic handler for handling the reagent cartridges. The robotic handler is arranged in the reagent storage area and is configured to grip and move the reagent cartridges within the reagent storage area.

The system or device further comprises a control unit configured to control at least the operation of the locking mechanisms and of the robotic handler. The control unit can be a dedicated control unit governed by a higher ranked control unit or is preferably integrated in a control unit of the system or device, e.g. a computer device.

According to the present invention, the reagent storage area is subdivided in a loading zone, a storage zone and a pipetting zone. Depending on the implementation, the zones may be mapped to different areas of the reagent storage area. A loading zone is a zone where loading/unloading of reagent cartridges is possible and is preferably corresponding to at least a portion of the reagent drawers. The storage zone is a zone for storing reagent cartridges and may be a zone that is not accessible by an operator. Additionally or alternatively, the storage zone may correspond to at least a portion of the reagent drawers, preferably the portion that is not part of the loading zone. The pipetting zone is a zone where reagent cartridges are arranged when an assay type has to be performed and is accessible by a pipettor of the system or device. In a preferred embodiment, where the reagent drawers are arranged stacked, the pipetting zone is arranged above the reagent drawers, wherein the storage zone may be arranged below and behind the reagent drawers.

The reagent storage area further comprises a handling zone. The handling zone is not a zone spatially separated from the loading, pipetting and storage zone but is defined as a zone where safe operation of the robotic handler, preferably with unlocked reagent drawers, is possible, and which handling zone is not accessible to an operator due to security reasons.

The control unit is further configured to determine, based on instructions comprising at least an assay type to be performed in a run, if the necessary reagent cartridge is located in the handling zone of the pipetting zone. For this purpose, the control unit is configured to access data related to instructions for the laboratory system or device, in particular when the control unit is implemented in the control unit of the system or device. The instruction herein referred to generally contains far more informations, like the sample IDs of the samples to be tested, the assay protocol, the number of controls to be run etc., however, for the present invention, the control unit has only to gain knowledge on which assay type has to be performed in a scheduled run. Each assay type is associated with a respective reagent cartridge containing, as a rule, all the necessary specific reagents for performing the assay. General-purpose reagents that are used in different assay types are normally provided in bulk containers of higher volume. The control unit has furthermore knowledge of which reagent cartridges are currently present in the system or device, since upon loading of a reagent cartridge, an ID of the reagent cartridge (preferably a barcode or a RFID tag) is read and the necessary data is stored in a storage connected to the control unit. Therefore, the control unit can easily perform the determination whether the necessary reagent cartridge is located in the handling zone of the pipetting zone or not. If determination is successful, the control unit controls the locking mechanisms to unlock the at least two reagent drawers.

In a preferred embodiment of the invention, if above determination is not successful, the control unit is further configured to control the locking mechanism to lock the reagent drawer where the necessary reagent cartridge is located and then to control the at least one robotic handler to transfer the reagent cartridge from the reagent drawer to the handling zone of the pipetting zone and subsequently control the locking mechanism to unlock the reagent drawer that was previously locked. Preferably, locking of the reagent drawer is only performed only in the case where the necessary reagent cartridge is located outside of the handling zone.

In a further preferred embodiment of the present invention, in the case where above cited determination is unsuccessful and it is further determined that the necessary reagent cartridge is not located within the reagent storage area, to prompt an operator to load the necessary reagent cartridge into one of the at least two reagent drawers and, if necessary, to remove non necessary reagent cartridges from the at least two reagent drawers. The control unit, as cited above, has knowledge of which assay types are scheduled in the future and can therefore select the reagent cartridges that are not needed during the next batch run, the next two batch runs etc. Prompting of an operator may occur by means of a visual and/or acoustical signal emitted by the system or device. In addition or alternatively, the control unit can trigger a notification to the operator over a computer network (email, push message, chat message) or a mobile network (SMS, MMS, push message, chat message, phone call with a voice message that can be computer generated).

In a preferred embodiment, at least one of the pipetting zone or storage zone is a handling zone. In such an implementation, the handling zone therefore corresponds to the pipetting or storage zone, thereby simplifying operation of the system or device.

In a further preferred embodiment, the pipetting zone comprises n receptacles for reagent cartridges, the first m receptacles being arranged outside of the handling zone. The amount m of receptacles outside the handling zone is lower than the total amount of receptacles n, preferably with a ratio min of 1:4, more preferred, m is equal to 1 and n is equal to 4. The m receptacles are arranged preferably in a frontal part of the pipetting zone. In other words, taking the sliding direction of the reagent drawers as a reference, the m receptacles are arranged closer to an operator when facing the reagent drawers. The control unit is in this case configured to determine, based on instructions comprising n assay types to be performed in a run, if the necessary reagent cartridge is arranged in one of the first m receptacles, and if determination is unsuccessful, control the locking mechanism to lock the upper reagent drawer. Then, the control unit controls the at least one robotic handler to transfer the reagent cartridge from the reagent drawer to the one of the first m receptacles of the pipetting zone and to control the rlocking mechanism to subsequently unlock the reagent drawer that was previously locked.

In another preferred embodiment, the control unit is further configured to control the at least one robotic handler to transfer the reagent cartridge to and from a reagent cartridge receptacle of the storage zone to a reagent cartridge receptacle of the pipetting zone or the loading zone and simultaneously control the locking mechanism to lock the reagent drawers if one of the affected reagent cartridge receptacles are not arranged in the handling zone. This means that, if a reagent cartridge hast to be transferred by the robotic handler from or to a receptacle that is not in the handling zone, the respective drawer is locked.

Although described above with respect to the system or device of the present invention, the above description applies accordingly to the method according to the present invention.

### SHORT DESCRIPTION OF THE FIGURES

FIG. 1 depicts schematically a sectional view of a laboratory system or device according to the present invention.

### DETAILED DESCRIPTION OF THE FIGURES

The invention will be described now by way of preferred embodiments in connection with the drawings.

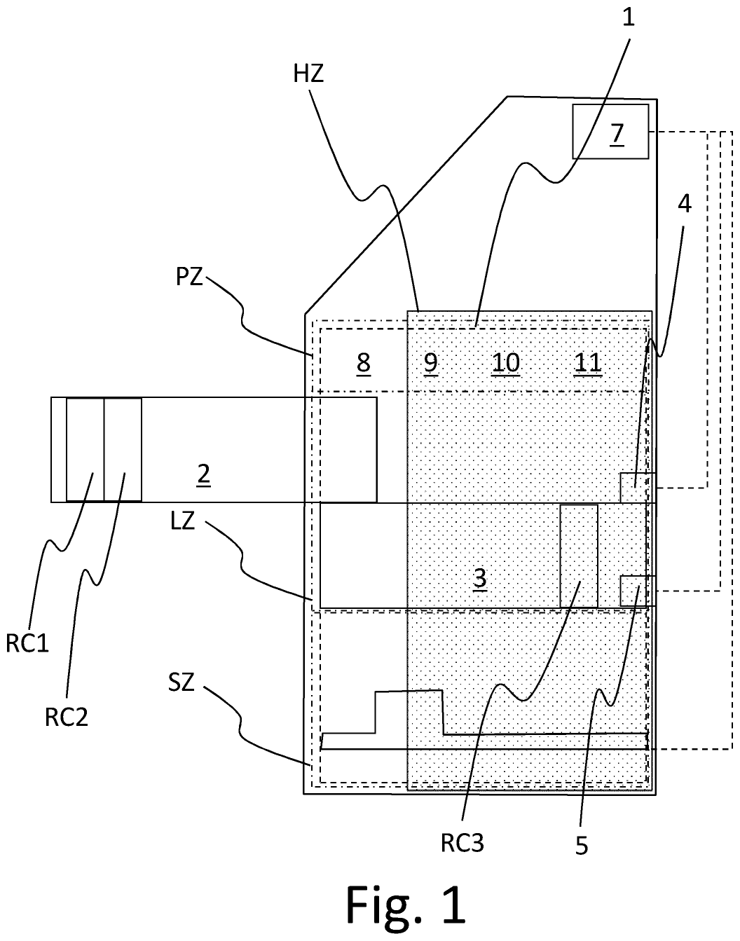

FIG. 1 shows schematically a sectional view of a laboratory system or device. The system or device comprises a reagent storage area 1 denoted by the dashed line. Arranged in the reagent storage area there are two reagent drawers 2 and 3, wherein the upper reagent drawer 2 is shown in the open position O and the lower reagent drawer 3 is shown in the closed position C. In the reagent drawer 2, two reagent cartridges RC1 and RC2 are arranged, while in the lower reagent drawer 3, a reagent cartridge RC3 is arranged. Locking mechanisms 4 and 5 are arranged in the reagent storage area that allow to lock the respective reagent drawer 2 or 3 in the closed position. A robotic handler 6 is also arrange in the system and allows the handling of the different reagent cartridges present in the reagent storage area 1. The robotic handler is in this case movably arranged along three axes (in the drawing the vertical and horizontal axis and an axis perpendicular to the drawing plane.

A control unit 7 is also arranged in the system or device and connected by the schematically shown dotted line with the locking mechanisms 4 and 5 and the robotic handler 6 in order to control operation of the locking mechanisms 4 and 5 and the robotic handler 6.

The reagent storage area 1 is subdivided in a loading zone LZ, a storage zone SZ and a pipetting zone PZ, shown by a chained line. In this particular embodiment, the pipetting zone is arranged above the drawers, the loading zone LZ corresponds to the area occupied by the reagent drawers 2 and 3 when these are in the closed position and the storage area SZ is arranged below the reagent drawers 2 and 3. A Handling zone HZ is also defined within the reagent storage area 1 and is shown in a pointed pattern. In this particular embodiment, the Handling zone HZ overlaps with the pipetting zone PZ, the loading zone LZ and the storage zone SZ.

Upon operation of the system or device, the reagent drawers are closed and the system or device is started.

The control unit 7 determines, which assay type are to be performed in a run and if the necessary reagent cartridge is located in the handling zone of the pipetting zone PZ.

For this purpose, the control unit 7 is configured to access data related to instructions for the laboratory system or device, in particular when the control unit 7 is implemented in the control unit 7 of the system or device. The instruction herein referred to generally contains far more informations, like the sample IDs of the samples to be tested, the assay protocol, the number of controls to be run etc., however, for the present invention, the control unit 7 has only to gain knowledge on which assay type has to be performed in a scheduled run. Each assay type is associated with a respective reagent cartridge containing, as a rule, all the necessary specific reagents for performing the assay. General-purpose reagents that are used in different assay types are normally provided in bulk containers of higher volume. The control unit 7 has furthermore knowledge of which reagent cartridges are currently present in the system or device, since upon loading of a reagent cartridge, an ID of the reagent cartridge (preferably a barcode or a RFID tag) is read and the necessary data is stored in a storage connected to the control unit 7. Therefore, the control unit 7 can easily perform the determination whether the necessary reagent cartridge is located in the handling zone HZ of the pipetting zone PZ or not. If determination is successful, the control unit 7 controls the locking mechanisms 4 and 5 to unlock the at least two reagent drawers 2 and 3. As an example, it is assumed that reagent cartridge RC1 is necessary in this case.

In the example of FIG. 1, determination is not successful and the control unit 7 therefore controls the locking mechanism 4 to lock the reagent drawer 2 and then to controls the at least one robotic handler 6 to transfer the reagent cartridge RC1 from the reagent drawer to the handling zone HZ of the pipetting zone PZ and subsequently controls the locking mechanism 4 to unlock the reagent drawer 2, which was previously locked. Preferably, locking of the reagent drawer is only performed only in the case where the necessary reagent cartridge is located outside of the handling zone HZ. This would be the case if reagent cartridge RC3 would have been needed instead of reagent cartridge RC1.

In a case were it would be determined that the necessary reagent cartridge (RC4 not shown) is not located within the reagent storage area 1, the control unit 7 would then alert an operator to load the necessary reagent cartridge RC4 into one of the at least two reagent drawers 2 or 3 and, if necessary, to remove non necessary reagent cartridges from the at least two reagent drawers.

In the example shown in FIG. 1, the pipetting zone PZ comprises four receptacles 8, 9, 10 and 11 for reagent cartridges, the first receptacle 8 being arranged outside of the handling zone HZ. The control unit 7 is in this case configured to determine, if the necessary reagent cartridge RC3 is arranged in one the first receptacle 8, which is not the case in this example.

In this case, the control unit 7 is configured to control the locking mechanism 4 to lock the upper reagent drawer 2. Then, the control unit 7 controls the at least one robotic handler to transfer the reagent cartridge RC3 from the reagent drawer 3 to the first receptacle 8 of the pipetting zone PZ and to control the locking mechanism 4 to subsequently unlock the reagent drawer 2 that was previously locked.

1. A laboratory system, comprising:
a reagent storage area comprising at least two reagent drawers mounted slidably between an open position and a closed position, each of the reagent drawers comprising receptacles for a plurality of reagent cartridges, and at least two locking mechanisms for respectively locking/unlocking the at least two reagent drawers when in the closed position,
at least one robotic handler for handling the reagent cartridges,
a control unit configured to control at least the operation of the locking mechanisms and of the robotic handler;
wherein, the reagent storage area is subdivided in a loading zone, a storage zone and a pipetting zone, the reagent storage area further comprises a handling zone, and the control unit is further configured to:
determine, based on instructions comprising at least an assay type to be performed in a run, if the necessary reagent cartridge is located in the handling zone of the pipetting zone, and
if the determination is successful, unlock the at least two reagent drawers.

2. The system of claim 1, wherein the control unit (7) is further configured to:
if the determination is unsuccessful, lock the reagent drawer where the necessary reagent cartridge is located,
control the at least one robotic handler to transfer the reagent cartridge from the reagent drawer to the handling zone of the pipetting zone, and
subsequently unlock the reagent drawer that was previously locked.

3. The system of claim 1, wherein the control unit is further configured to:
if the determination is unsuccessful and it is further determined that the necessary reagent cartridge is not located within the reagent storage area, prompt an operator to load the necessary reagent cartridge into one of the at least two reagent drawers and, if necessary, to remove non necessary reagent cartridges from the at least two reagent drawers.

4. The system according to claim 1, wherein at least one of the pipetting zone or storage zone is a handling zone.

5. The system according to claim 1, wherein the at least two reagent drawers are stacked.

6. The system according to claim 1, wherein the at least two reagent drawers are arranged in the loading zone.

7. The system according to claim 1, wherein the pipetting zone comprises n receptacles for reagent cartridges, the first m (m<n) receptacles being arranged outside of the handling zone, wherein the control unit is further configured to:
determine, based on instructions comprising n assay types to be performed in a run, if the necessary reagent cartridge is arranged in one of the first m receptacles, and
if the determination is unsuccessful, lock the upper reagent drawer,
control the at least one robotic handler to transfer the reagent cartridge from the reagent drawer to the one of the first m receptacles of the pipetting zone, and
subsequently unlock the reagent drawer that was previously locked.

8. The system according to claim 1, wherein the control unit is further configured to:
control the at least one robotic handler (6) to transfer the reagent cartridge (RC1, RC2) to and from a reagent cartridge receptacle of the storage zone (SZ) to a reagent cartridge receptacle of pipetting zone (PZ) or the loading zone (LZ),
simultaneously lock the reagent drawers (2, 3) if one of the affected reagent cartridge receptacles is not arranged in the handling zone (HZ).

9. A method for optimizing reagent handling of laboratory system, the laboratory system comprising:
a reagent storage area comprising at least two reagent drawers mounted slidably between an open position and a closed position, each of the reagent drawers comprising receptacles for a plurality of reagent cartridges, and at least two locking mechanisms for respectively locking/unlocking the at least two reagent drawers when in the closed position,
at least one robotic handler for handling the reagent cartridges,
a control unit configured to control at least the operation of the locking mechanisms and of the robotic handler;
wherein, the reagent storage area is subdivided in a loading zone, a storage zone and a pipetting zone, the reagent storage area further comprises a handling zone, the method comprising the following steps:
determining, by the control unit, based on instructions comprising at least an assay type to be performed in a run, if the necessary reagent cartridge is located in the handling zone of the pipetting zone, and
if the determination is successful, controlling, by the control unit, the locking mechanism to unlock the at least two reagent drawers.

10. The method of claim 9, further comprising the following steps:
if the determination is unsuccessful, the control unit controlling the locking mechanism to lock the reagent drawer where the necessary reagent cartridge is located,
controlling the at least one robotic handler to transfer the reagent cartridge from the reagent drawer to the handling zone of the pipetting zone, and
subsequently controlling the locking mechanism to unlock the reagent drawer that was previously locked.

11. The method of claim 9, further comprising the following steps:
if the determination is unsuccessful and the control unit further determines that the necessary reagent cartridge is not located within the reagent storage area, the control unit prompting an operator to load the necessary reagent cartridge into one of the at least two reagent drawers and, if necessary, to remove non necessary reagent cartridges from the at least two reagent drawers.

12. The method according to claim 9, wherein at least one of the pipetting zone or storage zone is a handling zone.

13. The method according to claim 9, wherein the at least two reagent drawers are arranged in the loading zone.

14. The method according to claim 9, wherein the pipetting zone comprises n receptacles for reagent cartridges, the first m (m<n) receptacles being arranged outside of the handling zone, the method comprising the following steps: the control unit:
determining, based on instructions comprising n assay types to be performed in a run, if the necessary reagent cartridge is arranged in one of the first m receptacles, and
if the determination is unsuccessful, controlling the locking mechanism to lock the upper reagent drawer,
controlling the at least one robotic handler to transfer the reagent cartridge from the reagent drawer to the one of the first m receptacles of the pipetting zone, and
subsequently controlling the locking mechanism to unlock the reagent drawer that was previously locked.

15. The method according to claim 9, further comprising the following steps performed by the control unit:
controlling the at least one robotic handler to transfer the reagent cartridge to and from a reagent cartridge receptacle of the storage zone to a reagent cartridge receptacle of pipetting zone or the loading zone,
simultaneously controlling the locking mechanism lock the reagent drawers if one of the affected reagent cartridge receptacles is not arranged in the handling zone.
